(19) United States
(12) Patent Application Publication
(10) Pub. No.: US 2025/0390816 A1
(43) Pub. Date: Dec. 25, 2025

(54) Computing Fairness

(71) Applicant: CrowdStrike, Inc., Sunnyvale, CA (US)

(72) Inventor: Stig Rohde Døssing, Aarhus V (DK)

(73) Assignee: CrowdStrike, Inc., Sunnyvale, CA (US)

(21) Appl. No.: 18/748,178

(22) Filed: Jun. 20, 2024

(51) Int. Cl. G06Q 10/0631; G06F 9/50

(52) U.S. Cl. CPC G06Q 10/06315; G06F 9/5016; G06F 9/5038

(57) ABSTRACT

Estimated and actual processor runtimes improve computer functioning in fairly sharing computing resources. Today's computers and cloud-based services serve many users and many software applications sharing CPU resources. An operating system thus implements a scheduling policy that fairly allocates CPU time. A scheduler thread implements the scheduling policy based on estimated processor runtimes, and actual processor runtimes, associated with tasks. The operating system may maintain running tallies or totals for a user/group/organization based on credits (e.g., the estimated processor runtimes) and/or on penalties (e.g., the actual processor runtimes). The scheduler thread may select tasks for worker threads based on the credits and/or the penalties, thus ensuring that no user/group/organization unfairly consumes CPU time.

### BACKGROUND

The subject matter described herein generally relates to computers and to operating systems and, more particularly, the subject matter relates to thread scheduling strategies and to allocation of CPU resources.

Today's computers seem very powerful. Modern computers certainly have fast processors and much memory. Indeed, every year the latest computers further push the performance envelope. Still, though, even high-performance computers must allocate hardware resources. Computers providing log management platforms and services, for example, request intensive CPU resources when processing large amounts of log data. Hardware resources are thus shared to ensure that all software applications, and all users, receive fair CPU time.

### SUMMARY

Estimated and actual processor runtimes improve computer functioning in fairly sharing computing resources. Today's cloud-based services and computers serve many users and many software applications sharing CPU resources. Log management platforms and services, for example, may receive many requests for log data from many different devices and users. An operating system thus implements a scheduling policy that fairly allocates CPU time between sharing users and software applications. A scheduler thread, for example, implements the scheduling policy based on estimated processor runtimes, and actual processor runtimes, associated with threads, processes, programming statements, queries, and other tasks. The operating system may maintain running tallies or totals for users/groups/organizations based on credits (e.g., the estimated processor runtimes) and/or on penalties (e.g., the actual processor runtimes). The scheduler thread may select tasks for worker threads based on the credits and/or the penalties, thus ensuring that no user/group/organization unfairly consumes CPU time.

### BRIEF DESCRIPTION OF THE SEVERAL VIEWS OF THE DRAWINGS

The features, aspects, and advantages of computing fairness are understood when the following Detailed Description is read with reference to the accompanying drawings, wherein:

FIGS. 1-2 illustrate some examples of computing fairness;

FIGS. 3-4 illustrate some examples of CPU usage;

FIGS. 5-8 illustrate some examples of estimated processor runtime;

FIGS. 9-11 illustrate some examples of actual processor runtime;

FIG. 12 illustrates some architectural examples of accounts;

FIG. 13 illustrates some examples of the computing fairness in a distributed database network;

FIGS. 14-15 illustrate examples of a mapreduce database framework;

FIG. 16 illustrates examples of nodal worker roles performing mapper phasing;

FIGS. 17-19 illustrate some examples of log management;

FIGS. 20-21 illustrate some examples of segment processing;

FIGS. 22-24 illustrate examples of different methods or operations that improve the computing fairness among worker threads; and

FIG. 25 illustrates a more detailed example of the operating environment.

### DETAILED DESCRIPTION

Even powerful computers share CPU resources. A desktop or laptop computer, for example, may have many software applications concurrently running (such as the MICROSOFT WORD® processor, the MICROSOFT OUTLOOK® email, the GOOGLE CHROME® browser, and the CROWDSTRIKE® security products). A user of a smartphone, as more examples, often concurrently opens a browser app, a text messaging app, a podcast app, a calendar app, and many other software applications. All these software applications allow the user to multi-task. All these software applications, though, compete for processor time. That is, even the latest hardware processors may not meet the many demands of many software applications. The software applications must share CPU resources, even when executed by powerful hardware processors.

Computer servers also share CPU resources. Computer servers also concurrently execute many different software applications. Moreover, as computer servers often provide many services and serve many different clients/users via communications networks, computer servers often perform even more work that must share CPU resources.

Some examples of this disclosure thus relate to computing fairness. Because even the best computers must share their CPU resources, computing fairness ensures that an entity (such as a software application, an individual user, a group, and/or an organization) receives a fair share of a hardware processor's capabilities. Every user, for example, may receive approximately equal CPU usage or time, when compare to other users sharing the same computer. No single software application, as another example, may unfairly monopolize CPU usage or time, as compared to other software applications executed by the same computer. Computing fairness thus distributes CPU resources to help ensure no user, group, or organization is disgruntled by slow or unresponsive computer performance.

Computing fairness will now be described more fully hereinafter with reference to the accompanying drawings. The concepts and schemes for computing fairness, however, may be embodied and implemented in many different forms and should not be construed as limited to the examples set forth herein. These examples are provided so that this disclosure will be thorough and complete and fully convey computing fairness to those of ordinary skill in the art. Moreover, all the examples of computing fairness are intended to encompass both structural and functional equivalents thereof. Additionally, it is intended that such equivalents include both currently known equivalents as well as equivalents developed in the future (i.e., any elements developed that perform the same function, regardless of structure).

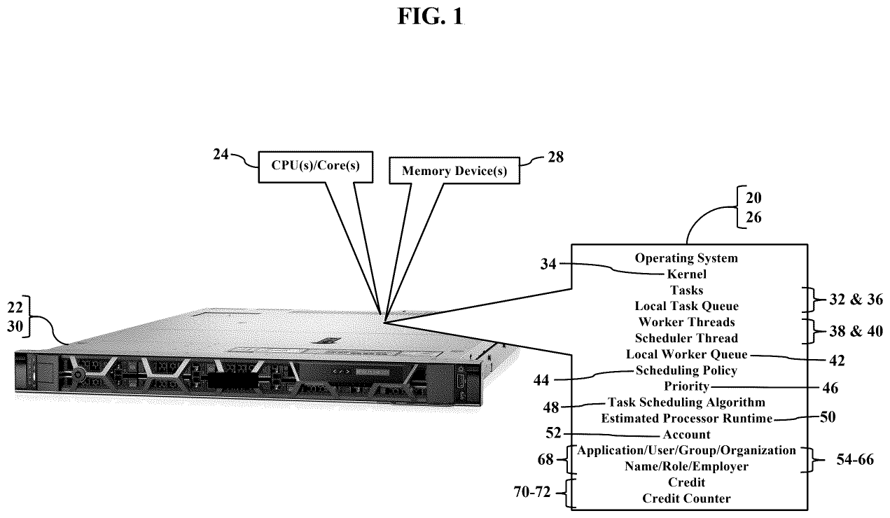

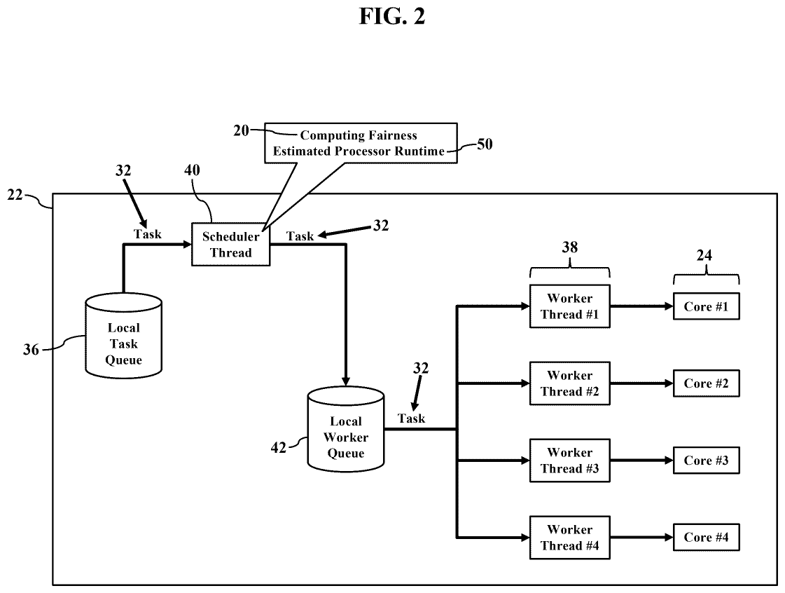

FIGS. 1-2 illustrate some examples of computing fairness 20. A computer system 22 has one or more hardware processors and/or processing cores (illustrated as CPU(s)/Core(s)) 24 that execute an operating system 26 stored in a local memory device 28. FIG. 1 illustrates the computer system 22 as a rack server 30, which is a common component in computer networking environments. The computer system 22, though, may be a laptop, tablet, desktop, or other processor-controlled device (as later paragraphs will explain). The operating system 26 orders tasks 32 that are processed and executed by the hardware processors/cores 24. A kernel 34, for example, is a software component of the operating system 26, and the kernel 34 controls how the tasks 32 utilize the processors/cores 24 and the local memory device 28. While the tasks 32 may be retrieved from a remote networked storage location, FIG. 1 illustrates local queuing of the tasks 32. The operating system 26 establishes a local task queue 36 in the local memory device 28. The local task queue 36 maps, associates, or identifies the tasks 32 for parallel, multi-thread processing by the multiple hardware processors/cores 24. As the server 30 has the multiple hardware processors/cores 24, the operating system 26 may establish a pool of worker threads 38 that service multiple requests from software applications (and/or users) competing for CPU time. The operating system 26 may thus also establish a scheduler thread 40 that determines which of the tasks 32 in the local task queue 36 are fed to the pool of worker threads 38 for execution by the multiple hardware processors/cores 24. The scheduler thread 40, in other words, identifies and pulls a task 32 from the local task queue 36 and adds/loads/transfers the task 32 to a local worker queue 42 associated with the worker threads 38. The operating system 26 establishes the local worker queue 42 in the local memory device 28. A worker thread 38 may thus pull the task 32 from the local worker queue 42 for processing and execution by a corresponding hardware processor/core 24.

The operating system 26 may implement a scheduling policy 44. Because the local task queue 36 may contain or reference millions of tasks 32 competing for CPU time, the scheduler thread 40 (established by the operating system 26) may assign a task priority 46 to each task 32 associated with the local task queue 36. Each task priority 46, assigned to the corresponding task 32, may be based on the task scheduling policy 44. The task scheduling policy 44 is represented by or executed by a task scheduling algorithm 48. The task scheduling algorithm 48 may be another software component or module of the operating system 26. When the server 30 executes the operating system 26, the task scheduling algorithm 48 instructs or causes the operating system 26, the kernel 34, and/or the scheduler thread 40 to assign the task priority 46 to the corresponding task 32. The operating system 26 may thus prioritize the individual task 32 in relation to the other tasks 32 in the local task queue 36. The scheduler thread 40 may then select and transfer the task 32 from the local task queue 36 to the local worker queue 42, perhaps based on the corresponding task priority 46. After the task 32 is transferred to the local worker queue 42, the operating system 26 and the hardware processors/cores 24 process and execute the task 32 according to the local worker queue 42 (e.g., FIFO or other prioritization scheme).

The task scheduling policy 44 may be based at least in part on an estimated processor runtime 50. That is, the operating system 26, the kernel 34, and/or the scheduler thread 40 may identify and/or prioritize the tasks 32 in the local task queue 36 according to their respective estimated processor runtimes 50 (such as microseconds). The operating system 26, the kernel 34, and/or the scheduler thread 40 reads each task 32 and generates its corresponding estimated processor runtime 50. The operating system 26, the kernel 34, and/or the scheduler thread 40 may then prioritize the tasks 32 in the local task queue 36 according to their respective estimated processor runtimes 50. The scheduler thread 40 may then select the task 32 having the highest/lowest/desired/targeted estimated processor runtime 50 and transfer the task 32 from the local task queue 36 to the local worker queue 42. The scheduler thread 40 may thus achieve the task scheduling policy 44 by populating the local worker queue 42 with the tasks 32 according to their estimated processor runtimes 50.

Accounting records may be kept. As the scheduler thread 40 selects the tasks 32 in the local task queue 36 (perhaps according to their respective estimated processor runtimes 50), the kernel 34, the operating system 26, and/or the scheduler thread 40 may log and track the selected task 32 and its estimated processor runtime 50. The scheduler thread 40, for example, may credit one or more accounts 52 associated with the task 32. The task 32, as examples, may be requested by, and/or associated with, a software application 54 (requesting execution of the task 32), a user 56, a group 58, and/or an organization 60. The task 32, as more examples, may be associated with an employee name 62, an employment role 64, and/or a corporate employer 66. Whatever the entity or entities 68, the scheduler thread 40 may log, track, accrue, and/or tally the estimated processor runtimes 50 according to each hierarchical entity 68 and the nested/hierarchical accounts 52. The scheduler thread 40 may thus monitor and maintain a running total of the estimated processor runtimes 50 accumulated by the account(s) 52 over time. The scheduler thread 40, as another example, may apply a credit 70 to one or more of the accounts 52 associated with the task 32, perhaps based on the estimated processor runtime 50. The scheduler thread 40, for example, may establish and maintain one or more credit counters 72 associated with the accounts 52. Each credit counter 72, for example, counts the credits 70 associated with the corresponding entity 68 and/or account 52. The credit counter 72 increments from an initial value to a final value, at which the credit counter 72 may reset. The scheduler thread 40, as another example, may evaluate and reconcile a current value of the credit counter 72 to the current value(s) associated with other accounts 52 and make task selections that maintain the computing fairness 20.

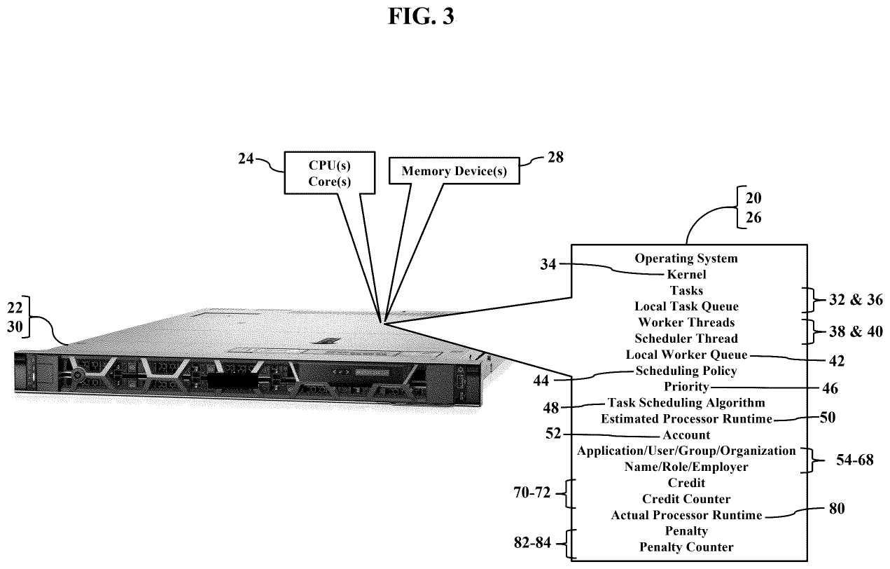

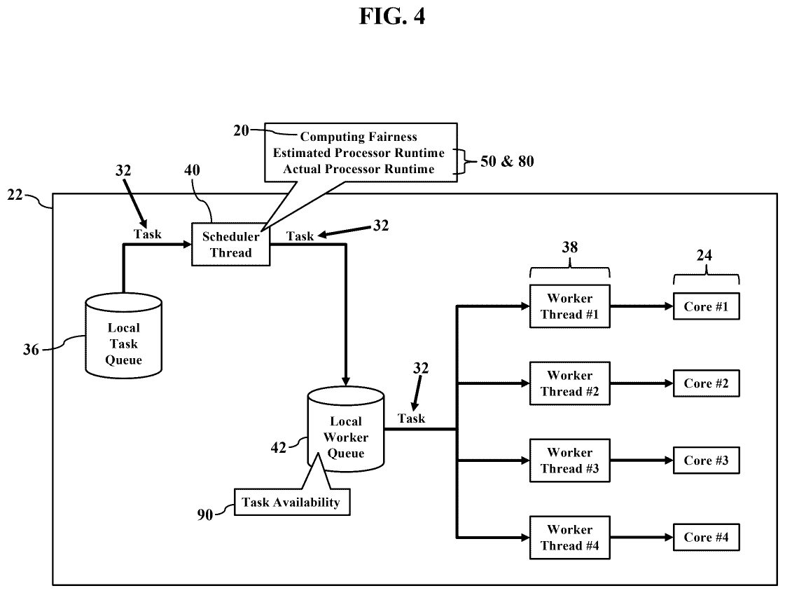

FIGS. 3-4 illustrate some examples of CPU usage. Here the task scheduling policy 44, represented by the task scheduling algorithm 48, may be additionally or alternatively based on an actual processor runtime 80 incurred by the task 32. That is, when the worker thread 38 processes the task 32 (e.g., pulled or assigned from the local worker queue 42), the kernel 34, the operating system 26, and/or the scheduler thread 40 may log and track the task 32 and its actual processor runtime 80. The actual processor runtime 80 represents, or is associated with, the time (perhaps in microseconds) that is/was required to execute the task 32 by the worker thread 38 and/or by the hardware processors/cores 24.

The task scheduling policy 44 may account for the actual processor runtime 80. As the tasks 32 are read, processed, and/or executed from the local worker queue 42, the scheduler thread 40 may log, track, and/or tally the actual processor runtime 80 accrued by each hierarchical entity 68 and the corresponding nested/hierarchical accounts 52. The scheduler thread 40, as examples, may monitor and maintain a running total of the actual processor runtimes 80 accumulated by the account(s) 52 over time. The scheduler thread 40, as another example, may apply a penalty 82 to the accounts 52 associated with the task 32, perhaps based on the actual processor runtime 80. The scheduler thread 40, for example, may establish and maintain one or more penalty counters 84 associated with the accounts 52. Each penalty counter 84, for example, counts the penalties 82 associated with the corresponding account 52. The penalty counter 84 increments from an initial value to a final value, at which the penalty counter 84 may reset. The scheduler thread 40, as another example, may evaluate and reconcile a current value of the penalty counter 84 to the current value(s) associated with other accounts 52 and make task selections that maintain the computing fairness 20.

The scheduler thread 40 may thus manage the computing fairness 20. The tasks 32 are likely associated with different software applications, different users, different groups, and different organizations (all illustrated as reference numerals 54-66). All these different entities 68 thus compete for CPU time. The task scheduling policy 44 may base the computing fairness 20 on both the estimated processor runtime 50 and the actual processor runtime 80. That is, the kernel 34, the operating system 26, and/or the scheduler thread 40 may select the tasks 32 in the local task queue 36 according to their respective individual or accrued estimated processor runtimes 50 and the individual or accrued actual processor runtimes 80. Because the scheduler thread 40, as examples, may monitor and maintain running totals of the estimated processor runtimes 50 and the actual processor runtimes 80 accumulated by the account(s) 52 over time, the tasks 32 in the local task queue 36 may be selected based on individual or accrued estimated processor runtimes 50 and the individual or accrued actual processor runtimes 80. The kernel 34, the operating system 26, and/or the scheduler thread 40, in other words, may balance the computing fairness 20 between the worker threads 38 based on individual/accrued estimated processor runtimes 50 and/or individual/accrued actual processor runtimes 80. The scheduler thread 40 may then select and transfer the task 32 (from the local task queue 36 to the local worker queue 42) based on the individual and/or accrued values associated with estimated processor runtimes 50 and/or individual/accrued actual processor runtimes 80.

The scheduler thread 40 thus provides fair and balanced access to the worker threads 38. The worker threads 38 are assigned work (e.g., the tasks 32) queued in the local worker queue 42. The tasks 32 queued in the local worker queue 42 are selected based on the individual and/or the accrued estimated processor runtimes 50 and/or the actual processor runtimes 80 associated with the account(s) 52. The scheduler thread 40, for example, uses the individual and/or the accrued estimated processor runtimes 50 and/or the individual and/or the accrued actual processor runtimes 80 to maintain and/or to achieve approximately equal account balances associated with the users/groups/organizations 56/58/60. The scheduler thread 40 selects tasks 32 in the local task queue 36 for transfer to the local worker queue 42 to maintain the computing fairness 20.

The task scheduling policy 44 may thus fairly distribute CPU time. The task scheduling policy 44 may balance the credits 70, and/or the penalties 82, associated with the accounts 52. The task scheduling policy 44, as examples, may strive to maintain approximately equal current values of the accumulated estimated processor runtimes 50 and/or accumulated actual processor runtimes 80 among one or more different accounts 52. No user 56, for example, may accumulate a greater value or amount of the estimated processor runtimes 50 and/or the actual processor runtimes 80, as compared to another user 56. No group 58, as more examples, may accumulate a greater value or amount of the estimated or actual processor runtimes 50 and 80 when compared to a different group 58. As still more examples, no customer/corporation/organization 60 may receive greater estimated or actual processor runtimes 50 and 80 when compared to a different customer/corporation/organization 60. The scheduler thread 40 may thus intentionally select tasks 32 in the local task queue 36 so as to maintain CPU fairness/usage among different user/role/customer accounts 52. Should a hierarchical/nested account 52 have a CPU time deficit or surplus compared to a different hierarchical/nested account 52, then the scheduler thread 40 may pick and transfer the task(s) 32 from the local task queue 36 to remediate the computing fairness 20.

The task scheduling policy 44 thus has at least two (2) different remedial fairness levers. When the local worker queue 42 has a task availability 90 (e.g., an open slot or position), the scheduler thread 40 fills or populates the task availability 90 by transferring a task 32 from the local task queue 36. As the scheduler thread 40 inspects and compares the balances of the accounts 52 across users/roles/organizations 56/58/60, the scheduler thread 40 maintains fair CPU usage/time by strategically picking the appropriate task 32 according to the balances of the accounts 52 across users/roles/organizations 56/58/60. The scheduler thread 40, as an example, balances the accounts 52 across users/roles/organizations 56/58/60 based on the estimated processor runtime 50 associated with the task 32. That is, by adjusting the estimated processor runtime 50, the scheduler thread 40 can increase or decrease the actual processor runtime 80 associated with one or more of the accounts 52. The scheduler thread 40, as an example, may transfer a task 32 having a longer estimated processor runtime 50, thus increasing the actual processor runtime 80 associated with the account(s) 52 and increasing an account holder's CPU usage. The scheduler thread 40, as another example, may transfer a different customer's tasks 32 to increase the actual processor runtime 80 and to balance out the CPU time surplus. The scheduler thread 40 may thus select and transfer subsequent tasks 32 from the local task queue 36 to update/adjust the computing fairness 20.

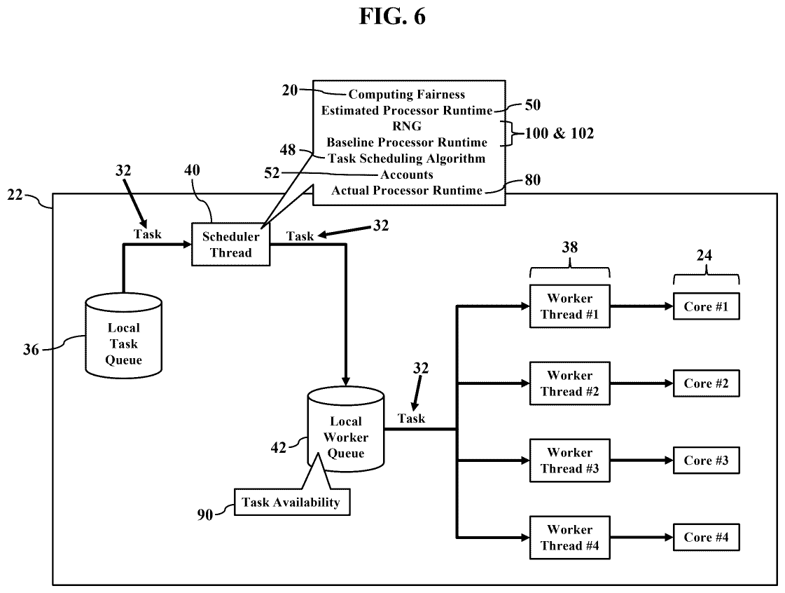

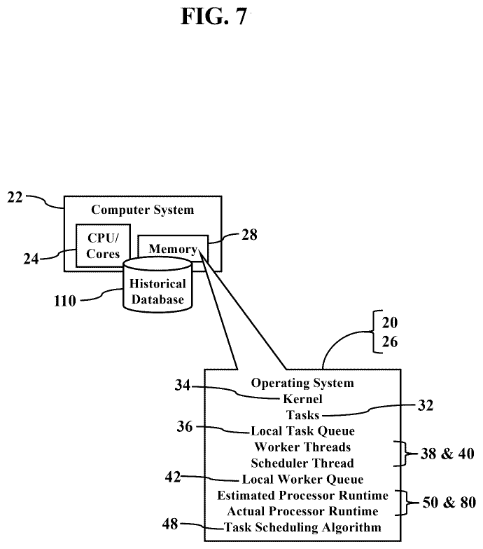

More examples help explain the computing fairness 20. The scheduler thread 40 may maintain the computing fairness 20 (e.g., fair or approximately equal CPU time) by transferring tasks 32 from the local task queue 36 into the local worker queue 42. The scheduler thread 40, for example, may decide which task(s) 32 to transfer by tallying accumulated/historical actual processor runtime 80 for the user 56 (i.e., the CPU time that user's tasks 32 have actually spent so far), plus the estimated processor runtime 50 for the tasks 32 already transferred/assigned to the local worker queue 42 but have not yet finished executing. Indeed, the scheduler thread 40 may generate the estimated processor runtime 50 using historical runtimes (as explained with reference to FIGS. 6-7). Indeed, historical estimations have shown to be adequate to maintain the computing fairness 20.

The scheduler thread 40 thus fairly allocates CPU resources. The hardware processor and its multiple cores 24 ideally operates at 100% electrical power from a power supply (not shown for simplicity). The hardware processor and its multiple cores 24 also ideally runs each task 32 at precisely equal speed in parallel. In actual operation, though, the hardware processor may not operate or receive full electrical power, and its multiple cores may not run at equal speed. The scheduler thread 40 therefore implements the computing fairness 20 to ensure each task 32 receives a fair share of CPU time.

The scheduler thread 40 may thus prioritize the tasks 32 based on the estimated processor runtime 50 and/or the actual processor runtime 80. Every task 32 and/or worker thread 38 may have the corresponding priority 46. Threads 38, for example, created within the common language runtime may be initially assigned normal priority (e.g., ThreadPriority.Normal). Threads 38 created outside the runtime may retain the priority 46 they had before they entered the managed environment. The priority 46 may be set using a property value, tag, or parameter (e.g., thread.Priority). Threads 38 are scheduled for execution based on their priority 46. Even though threads 48 are executing within the runtime, all threads 48 are assigned processor time slices by the operating system 26. The details of the task scheduling algorithm 48 used to determine the order in which threads 38 are executed varies with each operating system 26. Under conventional operating systems, the thread with the highest priority (of those threads that can be executed) is always scheduled to run first. If multiple threads with the same priority are all available, the scheduler cycles through the threads at that priority, giving each thread a fixed time slice in which to execute. As long as a thread with a higher priority is available to run, lower priority threads do not get to execute. When there are no more runnable threads at a given priority, the scheduler moves to the next lower priority and schedules the threads at that priority for execution. If a higher priority thread becomes runnable, the lower priority thread is preempted and the higher priority thread is allowed to execute once again. On top of all that, the operating system can also adjust thread priorities dynamically as an application's user interface is moved between foreground and background. Other operating systems might choose to use a different scheduling algorithm.

The scheduler thread 40, implementing the task scheduling policy 44, thus prioritizes the tasks 32 into the hardware processor/cores 24. The scheduler thread 40 thus schedules the tasks 32 on top of, or prior to the OS scheduling conducted by the operating system 26. The operating system 26, for example, is responsible for assigning the threads 48 to the cores 24, at the kernel level. At the application level, though, where the scheduler thread 40 operates, the scheduler thread 40 loads the local worker queue 42 with the tasks 32. The operating system 26, though, decides whether or not to run those threads 48. The scheduler thread 40 decides which pieces of work those threads 48 should do, and in which order, but the operating system 26 autonomously rules thread execution by the hardware processor/cores 24. The scheduler thread 40 thus solves computing fairness 20 at a different level of the software stack. The operating system 26 allocates the threads 48 to cores 24, while the scheduler thread 40 allocates work to the threads 48.

The computing fairness 20 may be implemented regardless of the operating system 26. Familiar examples of the operating system 26 include a version of MICROSOFT WINDOWS®, APPLE MACOS® and IOS®, GOOGLE ANDROID®, UNIX®, and LINUX®. Indeed, the computing fairness 20 may be adapted to other operating systems 26.

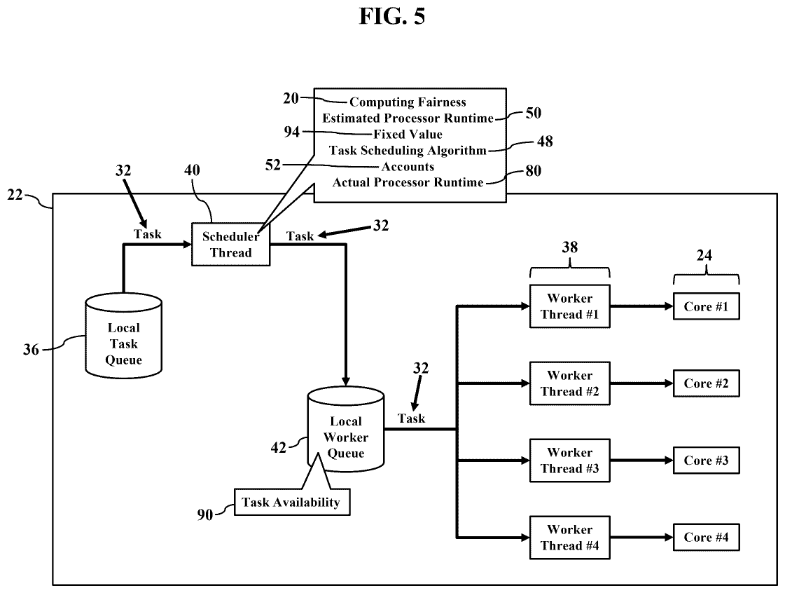

FIGS. 5-8 illustrate more examples of the estimated processor runtime 50. FIG. 5, for example, illustrates a simple and effective scheme for determining the estimated processor runtime 50 associated with the task 32. The kernel 34, the operating system 26, and/or the scheduler thread 40 may select the tasks 32 from the local task queue 36 according to their corresponding estimated processor runtimes 50. Here, then, the estimated processor runtime 50 may be a fixed value 94. The estimated processor runtime 50, in other words, may be the fixed value 94, regardless of the task 32. All tasks 32 may be assigned the same fixed value 94. This equally-assigned fixed value 94 ensures that all newly submitted tasks 32 (and/or jobs of multiple tasks 32) initially run with equal priority 46. As the tasks 32 (and/or jobs of multiple tasks 32) are executed, historical knowledge is accumulated and the estimated processor runtime 50 may be refined for accuracy when selecting remaining tasks 32 for that job.

Suppose, for example, the user 56 submits a job consisting of one thousand (1000) individual tasks 32. The kernel 34, the operating system 26, and/or the scheduler thread 40 may, initially, start by assuming each task 32 from that job takes 10 ms (e.g., the estimated processor runtime 50). The scheduler thread 40, for example, may be configured to initially set the fixed value 94 at 10 ms. Let us further assume that there is only one (1) competing job running, and historically its competing tasks 32 have been measured as taking one (1) second of CPU time each. The scheduler thread 40, for example, may then transfer 100 tasks for the new job to the local worker queue 42 every time one (1) task 32 from the old, competing job is transferred. As the new job's tasks 32 complete, the scheduler thread 40, for example, may measure how long the tasks 32 took, which refines the estimated processor runtime 50. As another example, if five (5) tasks for the new job at the current moment in time have completed, and that took one (1) second in CPU time in total, then the scheduler thread 40 may update the estimated processor runtime 50 to 200 ms per task 32 for that job. Going forward, then, the scheduler thread 40 may only transfer five (5) tasks 32 for the new job per one (1) task 32 from the old job. So, even though the scheduler thread 40 initially assigned the fixed value 94 for all new jobs, as each job's individual tasks 32 complete, the scheduler thread 40 may adjust estimated processor runtime 50 to be based on the historically-observed actual processor runtimes 80 (e.g., how much time previous tasks 32 for the job took to complete on average).

The initial, fixed value 94 for the estimated processor runtime 50 may be strategically chosen. The fixed value 94, for example, may be configured as reasonably low in comparison to real measured values historically-observed in practice. The scheduler thread 40, in the above example, was initially configured to set the fixed value 94 at 10 ms. This reasonable, low-value initial setting ensures new jobs actually get to run a few tasks 32, thus gathering data about how long their tasks 32 take. The fixed value 94, in other words, errs on the side of being too optimistic about how fast jobs (such as database queries) are, because the mix of queries is usually such that most queries are cheap, and perhaps only a small minority are expensive. But as soon as real measurements (e.g., CPU times) are determined, those actual/historical records may be used for refining and calculating the estimated processor runtime 50 rather than using the fixed value 94. The initial fixed value 94 may thus only be used when the job has completed zero (0) tasks 32 so far. The fixed value 94, however, may be configured at another fixed value 94 to suit other strategies.

FIG. 6 illustrates random estimation of the estimated processor runtime 50 associated with the task 32. The kernel 34, the operating system 26, and/or the scheduler thread 40 may select the tasks 32 from the local task queue 36 according to their corresponding estimated processor runtimes 50. Here, then, the estimated processor runtime 50 may be determined using a random number generator (or RNG) 100. The random number generator 100 generates a random number (such as 0≤value≤1) and applies the random number to a baseline processor runtime 102 (such as 1 second). The scheduler thread 40, and/or the task scheduling algorithm 48, as more examples, may implement the random number generator 100 to merely determine an initial guess of the estimated processor runtime 50 associated with the task 32. Assume, for example, that the random number=0.85. The task's estimated processor runtime 50 may thus be calculated as (0.85×1 second)=0.85 second. As the scheduler thread 40 inspects and compares the balances of the accounts 52 across the users/roles/organizations 56/58/60 (illustrated in FIGS. 1-4), the scheduler thread 40 may maintain the computing fairness 20 by selecting, or by declining, the task 32 having the estimated processor runtime 50 of 0.85 second. The scheduler thread 40 may thus use the estimated processor runtime 50 to cure or to alleviate a CPU time deficit or CPU time surplus associated with the account(s) 52. The scheduler thread 40, in other words, may predict the computing fairness 20 using the estimated processor runtime 50 associated with the corresponding task 32.

Whether the estimated processor runtime 50 is initially fixed or randomly chosen, the account(s) 52 may be updated. Once the task 32 is transferred to the local worker queue 42 and/or executed, the operating system 26 determines the actual processor runtime 80. The kernel 34 and/or the operating system 26, for example, may monitor the actual processor runtime 80. The kernel 34 and/or the operating system 26, as more example, may inform or notify the scheduler thread 40 and/or the task scheduling algorithm 48 of the actual processor runtime 80 consumed by the task 32. The scheduler thread 40 (perhaps implementing and/or executing the task scheduling algorithm 48) may then use the actual processor runtime 80 to update the running totals associated with the account(s) 52. The kernel 34, the operating system 26, and/or the scheduler thread 40 may thus update the balances of the account(s) 52 associated with the task 32 (such as the credit(s) 70 and the penalties 82 illustrated in FIG. 1-4), thus refining the current statuses or values associated with the computing fairness 20. The scheduler thread 40 may thus select the subsequent task 32 to transfer to the local worker queue 42 based on the current individual or running totals associated with the account(s) 52.

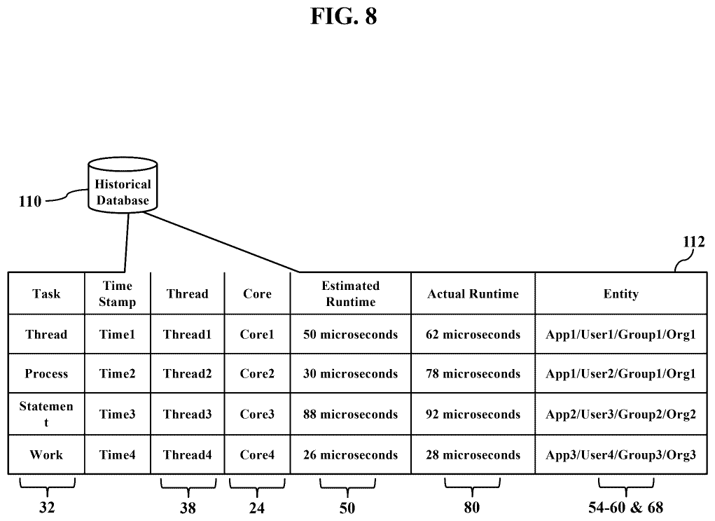

FIGS. 7-8 illustrate historical estimations. The kernel 34, the operating system 26, and/or the scheduler thread 40 may access a historical database 110 of processor runtimes. The historical database 110 of processor runtimes logs and tracks the tasks 32 for historical analysis and current prediction of CPU times (e.g., refining or predicting the estimated processor runtime 50). While the historical database 110 of processor runtimes may be stored and maintained at a network-accessible location, FIG. 7 illustrates local storage in the local memory device 28. Each task 32, for example, may belong to, or be a part/component of, a bigger job (which, in turn, belongs to the user/role/organization 56/58/60). As a simple example, the historical database 110 of processor runtimes may track of two (2) things for each job: how many tasks 32 have been completed thus far (e.g., a simple count/tally/sum); and how much CPU time (e.g. the cumulative actual processor runtime 80) was required, cumulatively, to complete all those tasks 32 (e.g., a simple count/tally/sum). Whenever a task 32 completes, the operating system 26 adds or updates entries in the historical database 110 of processor runtimes which job it belongs to, and how long it took to complete the task 32. The scheduler thread 40, as an example, may increment how many tasks 32 are complete and add the CPU time to the accumulating counters 72 and/or 84. The scheduler thread 40, as an example, may then easily calculate the average actual processor runtime 80 per task 32 for the job (e.g., totalTime/completedTaskCount), without keeping track of individual tasks 32 once they have completed. Because the historical database 110 of processor runtimes need only track how many tasks 32 have completed thus far, and how much CPU time (e.g. the cumulative actual processor runtime 80) was required, the historical database 110 of processor runtimes consumes minimal memory bytes and is a small, perhaps negligible, processing burden.

FIG. 8, though, illustrates a more detailed example of record keeping. Here the historical database 110 of processor runtimes logs the tasks 32 that were previously assigned to each worker thread 38 and/or by the hardware processor/cores 24. The historical database 110 of processor runtimes also logs and tracks the corresponding estimated processor runtimes 50 and the actual processor runtimes 80. This example of the historical database 110 of processor runtimes consumes more memory bytes and requires more processing burden. When the kernel 34, the operating system 26, and/or the scheduler thread 40 loads/reads the task 32 to/in the local task queue 36, the task 32 may also be compared to the database entries associated with the historical database 110 of processor runtimes. The scheduler thread 40 (implementing or executing the task scheduling algorithm 48), as an example, may query the historical database 110 of processor runtimes for the task 32 and identify a matching or similar historical task 32 and its historical actual processor runtime 80. The task scheduling algorithm 48 may thus assign the historical actual processor runtime 80 as the estimated processor runtime 50 associated with the task 32.

As FIG. 8 illustrates, the historical database 110 of processor runtimes logs, timestamps, and/or tracks the tasks 32 that have been previously executed by the worker thread(s) 38 and/or by the hardware processor/cores 24. While the historical database 110 of processor runtimes may have other logical structures and implementations, a relational database is perhaps easy to understand. FIG. 8 thus illustrates the historical database 110 of processor runtimes as a table 112 having row and columnar entries that map, relate, or associate different threads, processes, sub/parent/grandparent processes, programming statements, work items, and other tasks 32 to their corresponding estimated processor runtimes 50 and actual processor runtimes 80. Indeed, as more examples, the historical database 110 of processor runtimes may even add entries that log the software application 54, the user/role/organization 56/58/60, and other entity 68 requesting the task 32. The kernel 34, the operating system 26, and/or the scheduler thread 40 may query the historical database 110 of processor runtimes for a query parameter and identify the corresponding database entries. The scheduler thread 40, as an example, may query for the current task 32 and retrieve historical values for the estimated processor runtime 50 and/or the actual processor runtime 80 associated with the current task 32. The historically similar task 32, as more examples, may even have the same user/role/organization 56/58/60 as the current task 32, thus further lending credence or confidence in the estimated processor runtime 50. The historical database 110 of processor runtimes thus represents a rich repository of task/thread processing information that may be leveraged to maintain and to reconcile the computing fairness 20 between competing entities 68.

The computing fairness 20 may be time bound. The historical database 110 of processor runtimes may store and reference long periods (e.g., months or years) of detailed records. In actual practice, though, the computing fairness 20 may only be evaluated during shorter intervals, such as fast/short time slices (perhaps only minutes, seconds, or less). Indeed, once an individual thread, process, programming statement, query, or other task 32 completes, the scheduler thread 40 need no longer track that same task 32. The CPU time has been shared, so the scheduler thread 40 reconciles the computing fairness 20 and selects the subsequent task 32 according to new or updated account balances. While the historical database 110 of processor runtimes may log many different tasks 32 and their corresponding processor runtimes 50 and 80, the computing fairness 20 may be re-evaluated every seconds or less. The CPU usage, in other words, may be fairly shared over short time slices measured in fractions of a second.

CPU time is fairly shared for running jobs. Again, each job may be composed of multiple tasks 32. While two jobs are running (such as for two separate/different users 56), the computing fairness 20 may be configured for reasonably and/or approximately equal CPU time among them. When CPU execution time is viewed/measured in a very short time slice (such as 1 second), the CPU time may not be evenly split between the users' respective jobs. For example, the scheduler thread 40 might run only tasks 32 for job 1 on the CPU 24 for a little while. But if that happens, the scheduler thread 40 will compensate later in time. The scheduler thread 40, for example, may allow job 2 to “catch up” by transferring multiple tasks 32 for that job, because it will have accumulated less running time than job 1, by virtue of not running in this time interval. As another example, when a job is not running, the unrunning job perhaps should not be accounted for in computing fairness 20. If job 1 has been running for 10 minutes, for example, and job 2 starts, job 2 should not get any advantages, because the time advantage job 1 has does not count because job 2 did not exist at the time. So the CPU time should be fairly shared, when viewed over slightly longer timeframes (such as 1+ second), among the jobs that are actually running for that full timeframe.

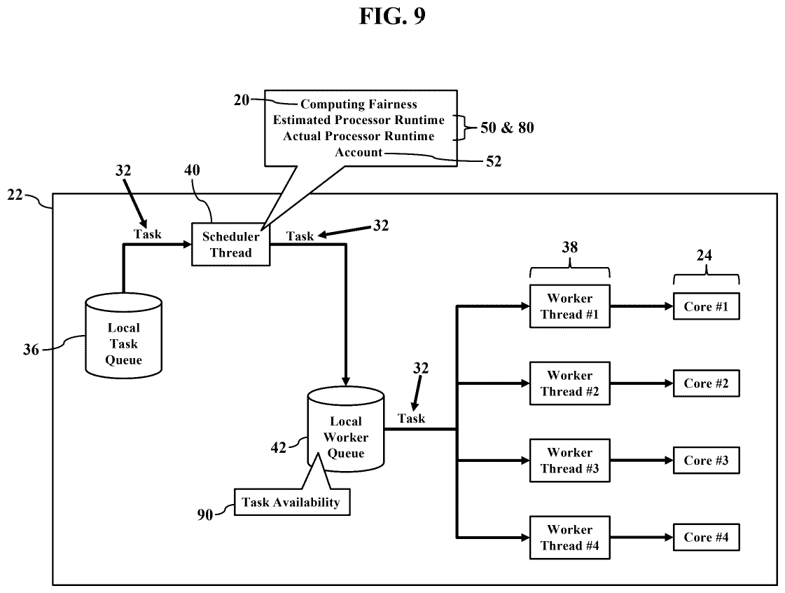

FIGS. 9-11 illustrate some examples of the actual processor runtime 80. The kernel 34 and/or the operating system 26, for example, may monitor the actual processor runtime 80 consumed by, or associated with, the worker thread 38 and/or the hardware processor/core 24. In FIG. 9, for example, the kernel 34 and/or the operating system 26 may monitor the actual processor runtime 80 in user space and/or in system/kernel space associated with the task 32. Once the actual processor runtime 80 is determined, the computing fairness 20 may be updated. The kernel 34 and/or the operating system 26, as examples, may notify the scheduler thread 40 of the actual processor runtime 80. The task scheduling algorithm 48, as more examples, may use the actual processor runtime 80 to update the running totals associated with the account(s) 52. The kernel 34, the operating system 26, and/or the scheduler thread 40 may thus update the balances of the account(s) 52 associated with the task 32 (such as the credit(s) 70 and the penalties 82), thus refining the current statuses or values associated with the computing fairness 20. The scheduler thread 40 may thus select the subsequent task 32 to transfer to the local worker queue 42 based on the individual or running totals associated with the account(s) 52.

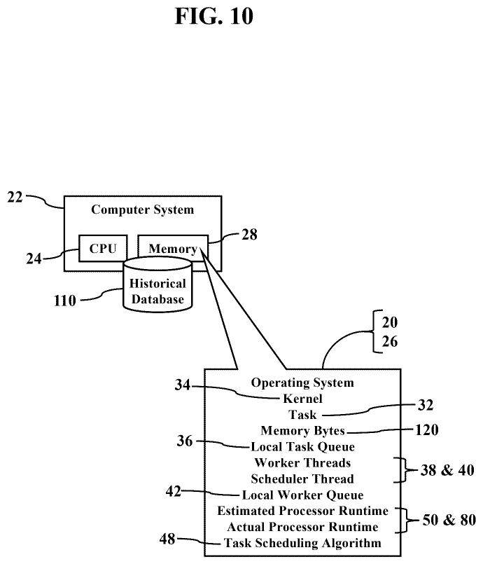

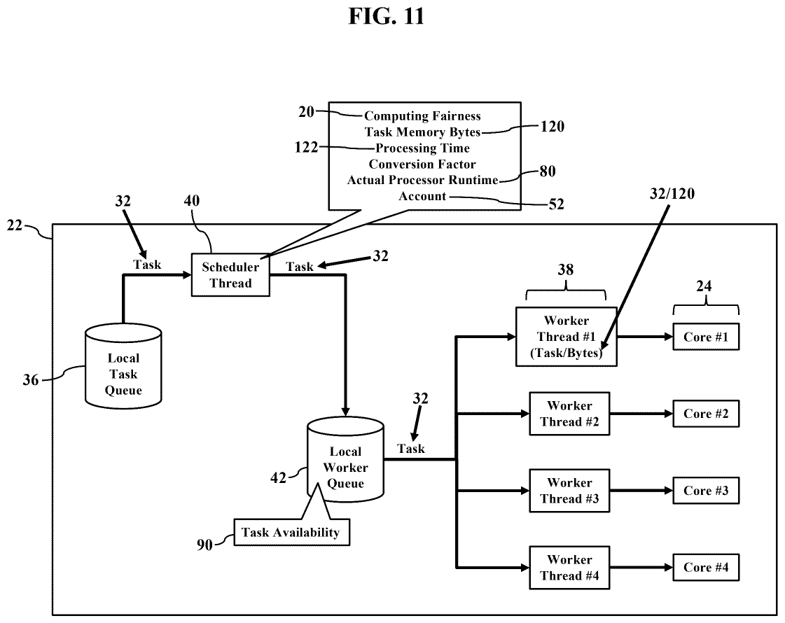

FIGS. 10-11, though, illustrate perhaps faster examples based on memory consumption. As or after the worker thread 38 pulls the assigned task 32 from the local worker queue 42, the worker thread 38 may retrieve and read the actual thread, process, program statement, work item, or other representation of the task 32 from the local memory device 28 (such as cache memory). The kernel 34, the operating system 26, and/or the scheduler thread 40 may thus count the memory bytes 120 associated with the task 32 that are read or scanned from the local memory device 28. The memory bytes 120 read or scanned from the local memory device 28 may thus correlate to, or be representative of, the actual processor runtime 80 associated with the task 32. The memory bytes 120, for example, may be converted to the actual processor runtime 80 using a processing time conversion factor 122 (for example, 1 GB of the local memory device 28 may be allocated as, or equal to, 32 seconds of actual processor runtime 80). A task 32 having a large number of bytes, for example, likely represents more processor work and thus a longer actual processor runtime 80. A different task 32 having a small bit/byte count, conversely, likely represents less processor work and thus a shorter/smaller actual processor runtime 80. So, by merely counting the memory bytes 120, the kernel 34, the operating system 26, and/or the scheduler thread 40 may quickly determine the actual processor runtime 80 consumed by, or associated with, the task 32. Once the actual processor runtime 80 is determined, the account(s) 52 may be updated. The scheduler thread 40, as examples, may input the actual processor runtime 80 into the task scheduling algorithm 48 to update the running totals associated with the account(s) 52. The kernel 34, the operating system 26, and/or the scheduler thread 40 may thus update the balances of the account(s) 52 associated with the task 32 (such as the credit(s) 70 and the penalties 82), thus refining the current statuses or values associated with the computing fairness 20. The scheduler thread 40 may thus select the subsequent task 32 to transfer to the local worker queue 42 based on the individual or running totals associated with the account(s) 52.

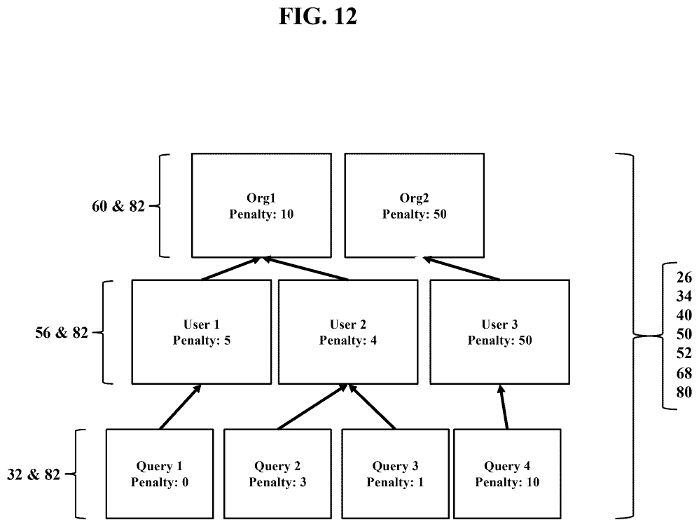

FIG. 12 illustrates some architectural examples of the accounts 52. The kernel 34, the operating system 26, and/or the scheduler thread 40 may establish the accounts 52 according to different entities 68. FIG. 12, for example, illustrates nested or hierarchical accounts 52 according to the task 32, the user 56, and the organization 60. Whatever the entity 68, the kernel 34, the operating system 26, the scheduler thread 40, and/or the task scheduling algorithm 48 may log, track, accrue, and/or tally the estimated processor runtimes 50 and the actual processor runtimes 80 according to each entity 68 and each account 52. FIG. 12, as examples, illustrates the various accounts 52 as a nested hierarchy of heaps (stored in the local memory device 28, as previously illustrated). The different organizations 60, for example, occupy or are associated with a top-level data structure. The different users 56 within each organization 60 occupy a middle data structure. The tasks 32 are associated with a bottom-level or lowest data structure. The nested hierarchy of the heaps may thus resemble a tree structure. Tasks 32 start at the smallest penalty 82 among their neighbors in the heap. A task 32 incurring the penalty 82 may also incur that penalty 82 for its corresponding user 56 and organization 60. The scheduler thread 40, as an example, may recursively inspect the lowest penalty 82 through the heap to select the task 32 to transfer to the local worker queue 42 (illustrated in FIGS. 1-10). The scheduler thread 40, in other words, compares the account balances to select the task 32 associated with the account 52 having the least actual processor runtime 80.

Computer functioning is thus greatly improved. The scheduling policy 44 is a simple and effective solution for the computing fairness 20 that consumes reduced hardware and software resources. Monitoring the estimated processor runtimes 50 and the actual processor runtimes 80 ensures the computing fairness 20 among the tasks 32, the users 56, and the organizations 60. All customers, for example, are assured of generally equal CPU time. No task 32 is overly penalized, especially by age. New tasks 32 may start close or approximately equal to existing tasks 32 in penalty 82, as the scheduling policy 44 makes it easier to keep a small span between minimum actual processor runtimes 80 and maximum actual processor runtimes 80. Moreover, the scheduling policy 44 governing the scheduler thread 40 is extremely cheap to implement, as no sorting of the local task queue 36 is required. Because the scheduling policy 44, based on the estimated and actual processor runtimes 50 and 80, consumes less memory and is independent of sorting tasks, less hardware and processor resources are required. Less electrical energy is consumed and less waste heat is generated. Computer functioning is thus greatly improved.

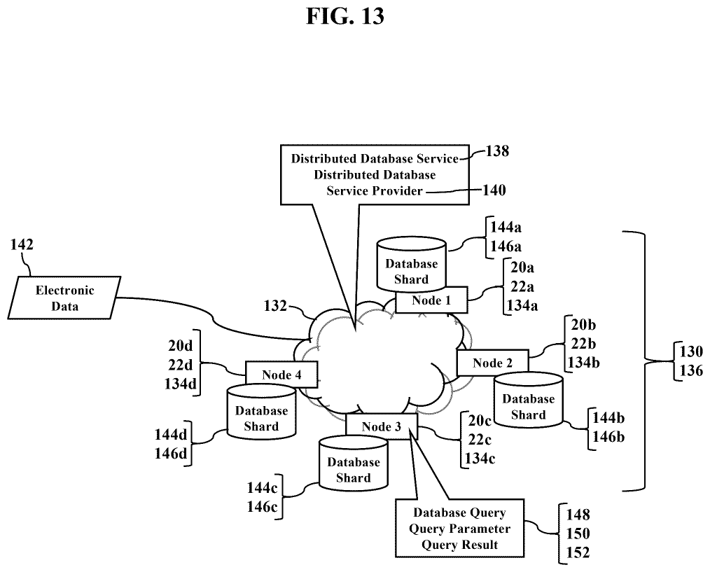

FIG. 13 illustrates some examples of the computing fairness 20 in a distributed database network 130. FIG. 13, for example, illustrates the distributed database network 130 as multiple computer systems 22 networked together via a communications network 132. Each computer system 22 may be considered a computer node 134 associated with a computing cluster 136. The computing cluster 136 provides a distributed database service 138 on behalf of a distributed database service provider 140. The distributed database service 138 distributes electronic data 142 among the computer systems 22 associated with the cluster 136. The distributed database service 138, in other words, distributes portions or shards 144 of an electronic distributed database 146 among the computer nodes 134. One of the computer nodes 134 may thus store its corresponding database shard 144. A manager and/or member of the distributed database network 130 (such as computer node 134c) may receive multiple database queries 148, and each database query 148 specifies is corresponding query parameter(s) 150. Because the distributed database 146 is distributed among the computer nodes 134, the distributed database network 130 may use a database scheme, technique, or management to generate an overall or total query result 152. Each computer node 134, for example, queries its shard 144 according to the query parameter(s) 150 specified by the corresponding database query 148. As there may be many hundreds, thousands, or even millions of the database queries 148, each computer node 134 may implement the computing fairness 20 to ensure each individual database query 148 obtains a fair share of hardware computing resources (such as the CPU time) provided by each computer node 134.

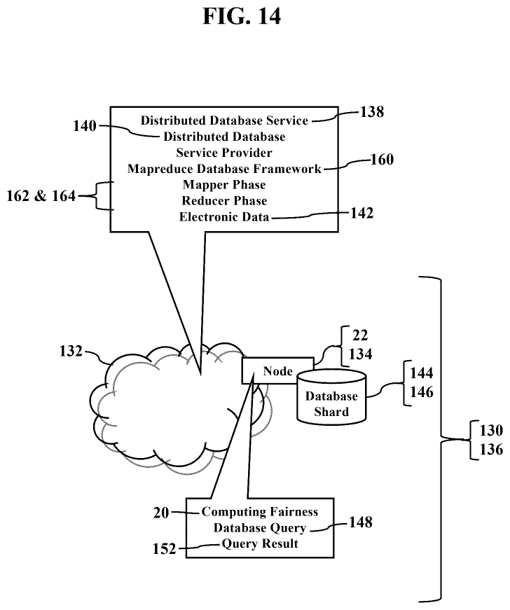

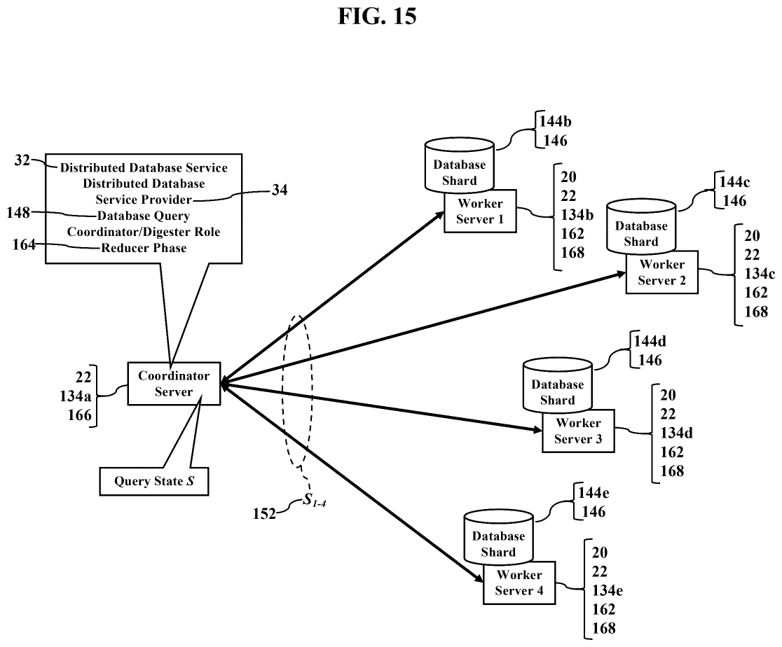

FIGS. 14-15 illustrate examples of the computing fairness 20 implemented in a mapreduce database framework 160. The distributed database service 138 may implement the mapreduce database framework 160 to store and to retrieve large datasets. The mapreduce database framework 160 may also implement the computing fairness 20 to ensure fair CPU access. The computing cluster 136 provides the distributed database service 138, and the computing cluster 136 uses the mapreduce database framework 160 to generate the query result 152 in response to each database query 148. The mapreduce database framework 160 uses mapping functions and reducing functions (hence the term mapreduce) to generate search results in large datasets. A mapper phase 162, for example, may be highly distributive and processes terabytes (TB) of the electronic data 142. A reducer phase 164, though, is centralized and processes/merges much smaller datasets to produce the final/reduced query result 46. The computer node 134 may implement the computing fairness 20 to ensure each database query 148 obtains a fair share of its hardware computing resources (such as the CPU time). FIG. 15, as another example, illustrates the computer node 134 functioning as a query coordinator or digester 166 (and perhaps performing at least a portion of the reducer phase 164). FIG. 15, as yet another example, illustrates the computer nodes 134b-134e functioning as workers 168 and perhaps performing at least a portion of the mapper phase 162. The query coordinator or digester 166 arranges subsequent processing of the nodal query results 152. Because the distributed database service 138 and the mapreduce database framework 160 may receive hundreds, thousands, or even millions of the database queries 148, each of the computer nodes 134 may implement the computing fairness 20 to ensure each individual database query 148 obtains a fair share of hardware computing resources (such as the corresponding CPU time). The mapreduce database framework 160 is generally used by many big data cloud services (such as AMAZON®, MICROSOFT®, IBM®, and CROWDSTRIKE®), so the mapreduce database framework 160 need not be explained in detail.

The distributed database service 138 is only simply described. The distributed database service 138 distributes the portions or shards 144 of the distributed database 146 among the computer nodes 134. In an actual data center or server farm, for example, the distributed database network 130 may have many different clusters 28, and each cluster 28 may have many (perhaps even hundreds or thousands) of the computer nodes 134 providing the distributed database service 138. Such a large computer cluster 136, though, is too confusing and too difficult to illustrate. FIG. 14, for simplicity then, only illustrates a simple example in which the cluster 136 has five (5) computing systems 22a-e as computer nodes 134a-e. Each computer node 134 may thus store its corresponding database shard 144. Each computer system/node 22/134 is associated with the cluster 136, but the computer systems 22 may have other geographical or logical grouping or organization (such as the aforementioned data center or even a single computer machine).

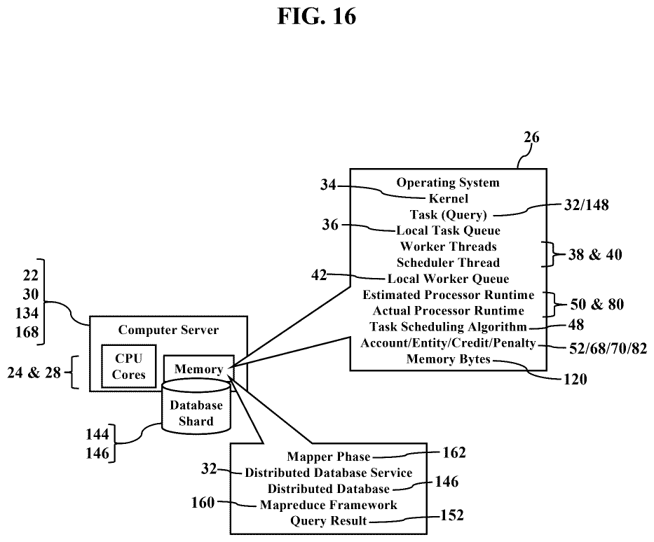

FIG. 16 illustrates more examples of the computer node 134 functioning as the worker 168 performing at least a portion of the mapper phase 162. The operating system 26 fills the local task queue 36 with the tasks 32. Because the worker 168 participates in the distributed database service 138, the worker 168 may participate in or implement the mapreduce database framework 160. Each task 32 may thus represent as at least a portion of the database query 148. The local task queue 36, in other words, may be loaded with threads, processes, programming statements, work items, or other tasks 32 representing the database queries 148. The scheduler thread 40 inspects each task 32 (such as the database query 148) in the local task queue 36 and estimates the corresponding estimated processor runtime 50 (perhaps using the using the random number generator 100 and/or the historical database 110 of processor runtimes, as explained with reference to FIGS. 4-8). The scheduler thread 40 (perhaps using the task scheduling algorithm 48) also establishes and compares the credit/penalty 70/82 balances associated with the nested/hierarchical accounts 52 associated with the database query 148. The scheduler thread 40, as examples, logs, tracks, and tallies the estimated processor runtimes 50 and the actual processor runtimes 80 according to each entity 68 and account 52 (perhaps using the min heaps, as explained with reference to FIG. 12). The scheduler thread 40, as more examples, compares the credits 70 and the penalties 82 associated with the accounts 52 to select the database query 148 to transfer the tasks 32 to the local worker queue 42. The scheduler thread 40, in simple words for example, compares the account balances to select the database query 148 associated with the account 52 having the least actual processor runtime 80. The scheduler thread 40 dequeues the candidate database query 148 from the local task queue 36 (perhaps based on the estimated processor runtime 50) and transfers the candidate database query 148 to the local worker queue 42 in order to maintain or achieve the computing fairness 20. A worker thread 38 of the pool of the worker threads 38 may then pull the database query 148 from the local worker queue 42 for execution. The worker 168 thus queries its database shard 146 and generates the corresponding query result 152.

The scheduler thread 40 queues the queries 148 in the local worker queue 42. The worker 168 executes the operating system 26 that causes the scheduler thread 40 to select the order of the queries 148 to execute by the worker threads 38, according to the computing fairness 20. The worker 168 may thus have two (2) sets of threads. The scheduler thread 40 submits work (e.g., the tasks 32, such as the database queries 148) to the pool of the worker threads 38 via queuing the local worker queue 42. The pool of the worker threads 38 performs segment processing. While other configurations may be used, the default pool sizing is one (1) worker thread 38 per two (2) cores 24. The local worker queue 42 is architecturally ahead of the pool of the worker threads 38, thus feeding the pool of the worker threads 38 with the tasks/queries 32/148 to ensure the worker threads 38 are kept busy and not idle.

The purpose and goal of the scheduler thread 40 is to ensure the computer system 22 feels responsive. The computing fairness 20 provides fair CPU time to users/queries, thus ensuring that new queries 148 get to run even if the computer system 22 is busy. The local task queue 36, at the top level, queues the queries 148, and each query 148 contains a queue of the segments ready for processing (for example, a file is believed to exist locally). The query 148 may be associated with the penalty 82 (such as the CPU time in nanoseconds spent on the worker threads 38). The scheduler thread 40, implementing the computing fairness 20, tracks allocations performed by a worker thread 38 on behalf of that database query 148 (for example, 1 GB of the memory device 28 may be allocated as, or equal to, 32 seconds of the actual processor runtime 80, as previously explained). The credits 70 and penalties 82 may be periodically updated by the scheduler thread 40 based on the current values of the counter(s) 72 and 84.

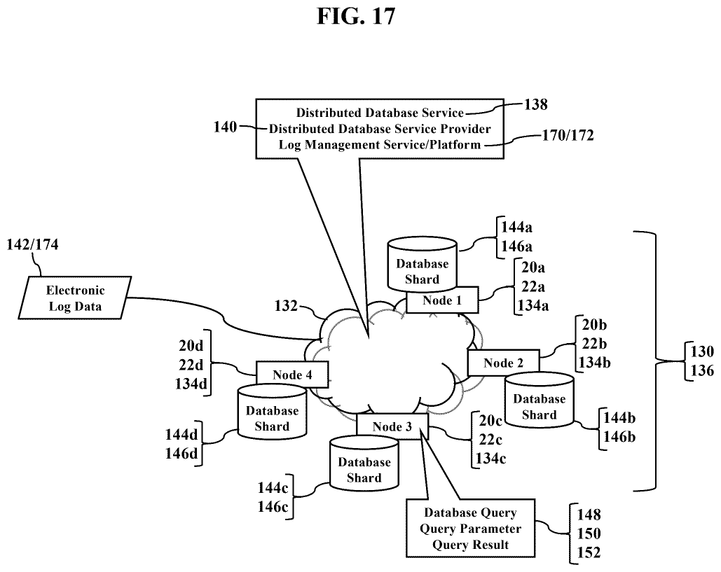

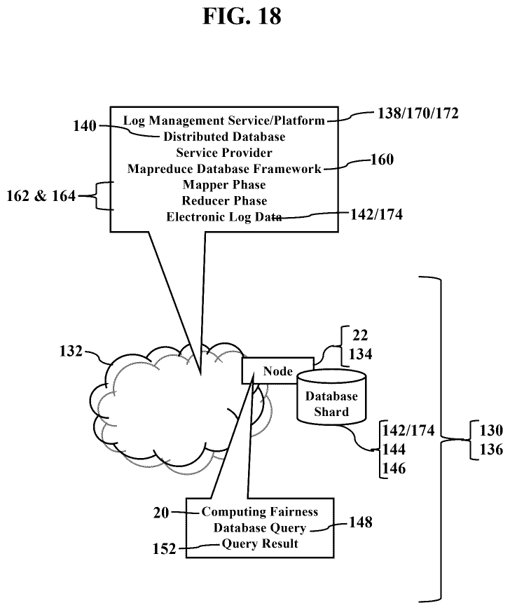

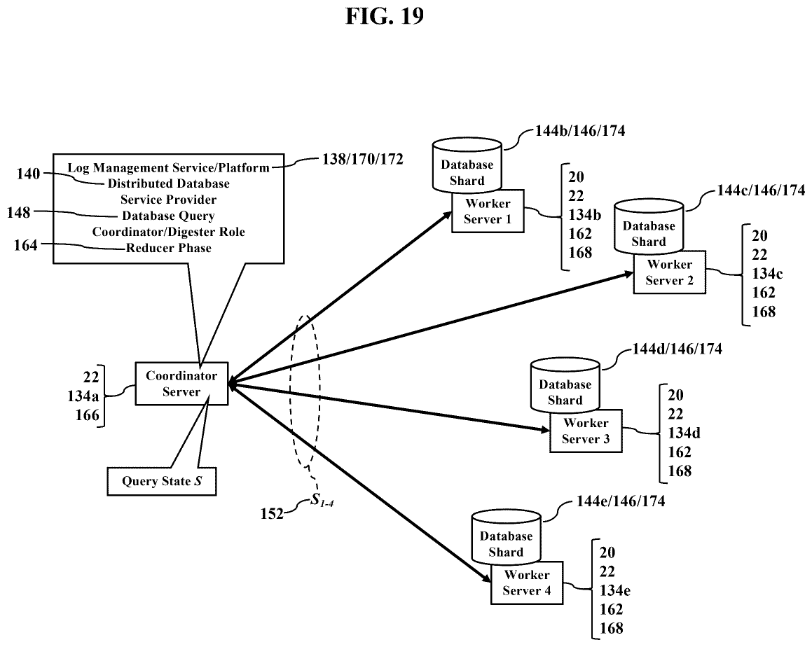

FIGS. 17-19 illustrate some examples of log management. The computing cluster 136 provides the distributed database service 138 on behalf of the distributed database service provider 140. The distributed database service 138, for example, may be a log management service 170 and/or a log management platform 172. The log management service/platform 170/172 may distribute electronic log data 174 among the computer systems 22 associated with the cluster 136. The log management service/platform 170/172 may thus distribute portions or shards 144 of the electronic distributed database 146 among the computer nodes 134. Because the log management service/platform 170/172 may ingest many petabytes (e.g., 250 bytes or millions of gigabytes) of the electronic log data 174, the distributed database service 28 may have many, perhaps even hundreds, of the computer systems 22 associated with many different clusters 136. Such a large number of the computer systems 22, though, is too difficult to illustrate. For simplicity, then, FIGS. 17-19 merely illustrate a small cluster size. Moreover, because the log management service/platform 170/172 may service many users/customers/subscribers, the database query 148 may require processing large datasets to generate the query result 152. The log management service/platform 170/172 may thus implement the mapreduce database framework 160 for more efficient processing of the log data 174. Because the log management service/platform 170/172 may receive hundreds, thousands, or even millions of the database queries 148, each of the computer nodes 134 may implement the computing fairness 20 to ensure each individual database query 148 obtains a fair share of hardware computing resources (such as the corresponding CPU time).

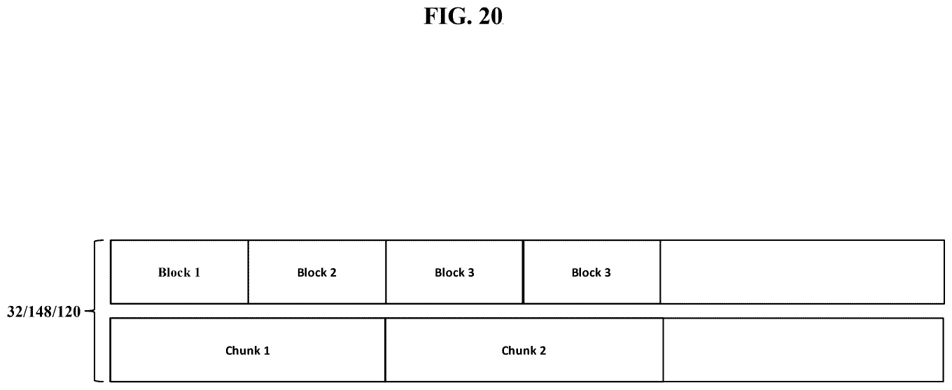

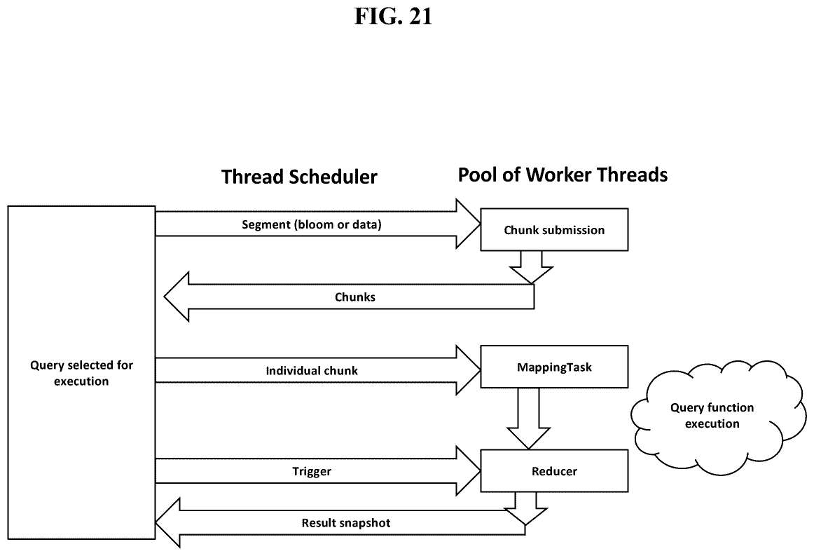

FIGS. 20-21 illustrate some examples of segment processing. Each task/query 32/148 is associated with its corresponding memory bytes 120. Each task/query 32/148 may be segmented into one or more segments, with each segment having a bit length. Each task/query 32/148, in other words, may be composed of or represented by segments, with each segment having a unique segment identifier. Each segment may thus be represented by, or consist of, blocks of bytes that may be independently processed. The blocks may then be grouped into chunks which represent a reasonable/desirable/targeted number of the memory bytes 120. Bloom filters, or other data representations, may then be read, and the relevant subset of the chunks are selected. The selected chunks are then queued by the scheduler thread 40 in the local worker queue 42. The scheduler thread 40 thus controls the population of, and perhaps the order of, the tasks 32, queries 148, and/or the chunks associated with the local worker queue 42. The scheduler thread 40, however, may have no control over the order/sequence of the tasks 32, queries 148, and/or the chunks picked and dequeued from the local worker queue 42. The hardware processor/cores 24, instead, may have a separate or different selection mechanism. Regardless, chunk submission runs on the worker threads 38.

The worker 168 executes the database query 148. Each task/query 32/148 may be associated with its corresponding memory bytes 120. Each task/query 32/148 may be segmented into one or more segments, with each segment having a bit length. Each task/query 32/148, in other words, may be composed of or represented by segments, with each segment having its corresponding unique segment identifier. The worker 168 may thus receive a list of the segment identifiers to search, plus other information to execute the query on a segment. The worker 168 may also receive metadata associated with each segment (such as user/group/organization identifiers). The worker 168 determines which of these segments are locally stored in the local memory device 28 and which segments must be fetched (such as from remote or bucket storage).

Computer functioning is again greatly improved. The scheduler thread 40, implementing the computing fairness 20, reasonably prioritizes CPU time among different users/groups/organizations 56/58/60. Because the scheduler thread 40 intelligently selects the tasks/queries 32/148 based on the estimated processor runtime 50 and the actual processor runtime 80, the scheduler thread 40 ensures the computing fairness 20 among the different tasks/queries 132/148 and their associated entities 68. All users 56, for example, are assured of generally equal CPU time. No single user 56, group 58, nor organization 60 may run hundreds of monopolizing queries 148 that prevent other users from getting CPU time. The scheduler thread 40, by tracking the individual and cumulative credits 70 and penalties 82, ensures that all customers receive approximately equal access to the worker threads 38, thus ensuring a reasonably pleasing user experience and perceived performance (e.g., within seconds). Moreover, because the estimated processor runtime 50 may be quickly and even accurately estimated, the scheduler thread 40 requires less hardware and software overhead than conventional prioritization schemes. Less processing time is consumed, and less memory is used. Less electrical energy is consumed and less waste heat is generated. Computer functioning is thus greatly improved.

More computer functioning is improved. Many operating systems implement a conventional schemes for thread scheduling. These conventional schemes for thread scheduling, though, are very complex and can involve complicated compromises based on differing notions of priority, niceness, stealing, and other concepts. The scheduler thread 40, implementing the computing fairness 20, is much simpler and a more elegant solution in which all work items (e.g., the tasks 32 and the database queries 148) have the same initial priority (no niceness or other arbitrary compensating factors). The scheduler thread 40, instead, tracks each entity's individual and cumulative estimated processor runtimes 50 and actual processor runtimes 80 to ensure the computing fairness 20. The scheduler thread 40, in other words, is a supervisory or boss mechanism that transfers the tasks/queries 132/148 to the single, local worker queue 42 feeding the worker threads 38. The worker threads 38 may only process the memory bytes 120 representing the segments. Moreover, the scheduler thread 40 may only dole out two different units of work (e.g., the segments and the chunks). Simply put, the scheduler thread 40 may select and transfer the task/query 32/148 associated with the lowest penalty 82 representing the needy entity's cumulative, actual processor runtime 80. The scheduler thread 40 thus provides reasonably fair and equal access to the worker's hardware and software resources without gimmicky or arbitrary compromises imposed by conventional operating systems. Computer functioning is thus fairly improved.

The scheduler thread 40 implements an elegant solution. The scheduler thread 40 causes the operating system 26 to generate the single, local worker queue 42 feeding work to the worker threads 38. Each task/query 32/148 may have an unordered list of segments and chunks. Should the task/query 32/148 have a priority of execution (such as the lowest penalty 82 associated with the cumulative, actual processor runtime 80), the operating system 26, the kernel 34, and/or the scheduler thread 40 may split segments if too few chunks are ready. The scheduler thread 40 may thus always submit a chunk into the local worker queue 42 for processing, if possible. The scheduler thread 40 reduces, or even eliminates, a need for sorting work in the local task queue 36, which is an easier, faster, and cheaper scheme. Moreover, by implementing the scheduler thread 40 and the local worker queue 42, the scheduler thread 40 is a single determinator of the penalty 82 associated with the task/query 32/148. Conventional schemes, with multiple queues, often disagree which work is to be prioritized. Moreover, the scheduler thread 40 implementing the computing fairness 20 is much less likely to run an expensive query 148, with open segments, over a cheap query 148 with no open segments (perhaps subject to global limits). The scheduler thread 40 may thus select the query 148 in the local task queue 36 representing the cheapest organization 60, then the cheapest user 56, and then the cheapest query 148. However, the so-called cheapest query 148 is measured by the actual processor runtime 80. The scheduler thread 40 may thus select the task/query 32/148 according to the users/groups/organizations 56/58/60 having the least actual processor runtime 80 as compared to other users/groups/organizations 56/58/60. Those tasks 32 associated with the lowest actual processor runtime 80 may have the highest priority 46.

The database queries 148 should complete. Even though the scheduler thread 40 controls the tasks 32 queued in the local worker queue 42, the queries 148 should not accrue so much penalty 82 that they never get to run. So, when a query 148 is submitted, the query 148 may starts close to or approximately equal with other tasks 32 in penalty terms. When a query 148 is unable to run (for whatever reason, such as waiting for bucket fetch or running into hard resource limits), the query 148 may be added to a side list away from the other queries 148. When the query 148 becomes able to run again, the query 148 may not get to keep all the penalty advantage. The penalty 82 may be adjusted to again be close to or nearly equal in value to the other queries 148. The difference between penalties 82 for running queries 148 always reflects recent penalty 82 (no query 148, in other words, may be punished for being expensive 10 minutes ago). Queries 148 that are blocked for a while don't get to save up so much penalty 82 that they are the only thing that runs once they become runnable.

The computing fairness 20 may account for asynchrony. Penalty 82, for example, may not be incurred when the estimated processor runtime 50 is estimated. The penalty 82, instead, may be later incurred by the worker thread(s) 38. That is, if nothing is done, the scheduler thread 40 may repeatedly pick the cheapest query 148, as enqueuing is free. In actual practice, though, the results may be undesirable, as a single, large query 148 could easily clog all the worker threads 38. Instead, the scheduler thread 40 may impose costs for starting a segment or chunks task 32 (e.g., enqueuing and estimating may be little cost or free). That is, when submitting a chunk, the credit 70 may be pre-paid, based on the estimated processor runtime 50. When the chunk incurs real cost (e.g., the actual processor runtime 80) in response to processing by the worker thread 38, that penalty cost goes toward paying down the prepay tab. Splitting of segments may have little effect on query priority, as it is more likely that the chunks will process when ready instead of switching to another query 148.

Bad estimates have much less effect on the computing fairness 20. One may think that incorrect values for the estimated processor runtime 50 would result in skewed, biased, or otherwise unfair CPU time. However, the scheduler thread 40 accounts for both the estimated processor runtime 50 and the actual processor runtime 80 accrued by each entity 68. If, for example, the estimated processor runtime 50 is too low, then the query 148 gets to enqueue more work than it should and prepays too little. However, the query 148 is then later punished (via the penalty counter 84) when the real cost (e.g. the actual processor runtime 80) is known. If, conversely, the estimated processor runtime 50 is too high, then the query 148 gets to enqueue too little work and prepays too much. However, the query 148 is then later compensated (via the penalty counter 84) when the real cost (e.g. the actual processor runtime 80) is known. The computing fairness 20 is maintained, even though the initial estimated processor runtime 50 may be grossly wrong.

The scheduler thread 40 ensures tasks 32 are ready for execution by the worker threads 38. The scheduler thread 40, for example, may limit the number of open segments. Too many open files may run into an OS limit, and one difficulty comes from chunk submission being asynchronous. The scheduler thread 40, for example, may have performance objectives that aim for having a set number of chunks ready for each query 148. The scheduler thread 40, as another example, may put a limit on how many chunk submissions a query 148 is allowed to do at a time. When a query 148 is currently top priority for execution, the scheduler thread 40 may split segments if not enough chunks are ready. These examples of performance objectives may be much faster at switching away from queries 148 that are expensive (no several-second delay to discover query shelving is needed). The scheduler thread 40 may thus never be prevented from running the cheapest query 148, because other queries 148 have many segments open. The scheduler thread 40 may be not as good at keeping the number of open segments down, as a freshly submitted query 148 will open a fair number. The number of open segments, as an example, may be bounded by a hard limit. Even so, if the hard limit were exceeded, the scheduler thread 40 may accept the short-term unfairness and process, or clear out, the open files. The scheduler thread 40 may thus temporarily accept unfairness and, instead, err on the side of not opening too many files. In actual practice, though, in nearly all times the scheduler thread 30 will achieve the computing fairness 20.

The actual processor runtime 80 may be expressed according to segments. For each task/query 32/148, the operating system 26, the kernel 34, and/or the scheduler thread 40 determines a count of how many segments must be scanned in total. The operating system 26, the kernel 34, and/or the scheduler thread also counts how many segments have been currently scanned. The penalty 82 divided by the number of segments currently scanned determines an approximation of the cost to process a single segment. So, when the task/query 32/148 is dequeued from the local task queue 36, the credit 70 is added to the corresponding user's aggregate credit 70, to the corresponding group's aggregate credit 70, and/or corresponding organization's aggregate credit 70. Then, when the task/query 32/148 is dequeued from the local worker queue 42 (e.g., the actual work is executed), the penalty 82 is added to the corresponding user's aggregate penalty 82, to the corresponding group's aggregate penalty 82, and/or corresponding organization's aggregate penalty 82. The scheduler thread 40, in other words, tracks and accrues the credits 70 and penalties 82 by the entities 68. The scheduler thread 40 thus implements the computing fairness 20 across different users 56, different groups 58, and different organizations 60. The scheduler thread 40 may then write the records of the computing fairness 20 to the local memory device 28 and/or to some other networked memory resource. The scheduler thread 40 thus elegantly enforces the computing fairness 20 to the worker threads 38.

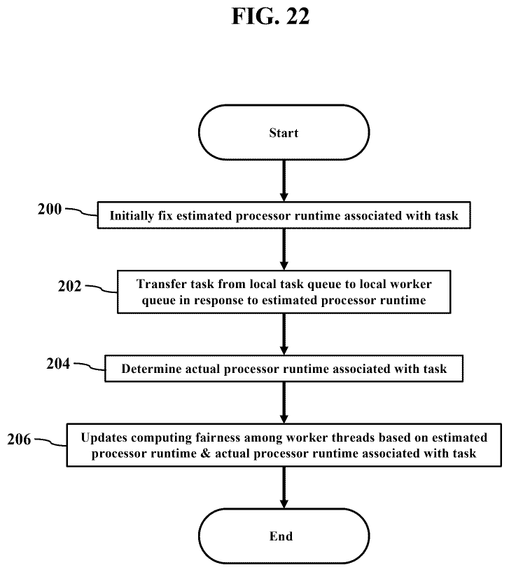

FIG. 22 illustrates examples of a method or operations executed by the operating system 26 that improves the computing fairness 20 among the worker threads 38. The scheduler thread 40 randomly estimates the estimated processor runtime 50 associated with the task 32 (Block 200). The scheduler thread 40 transfers the task 32 from the local task queue 36 to the local worker queue 42 in response to the estimated processor runtime 50 (Block 202). The scheduler thread 40 determines the actual processor runtime 80 associated with the task 32 (Block 204). The scheduler thread 40 updates the computing fairness 20 among the worker threads 38 based on the estimated processor runtime 50 and the actual processor runtime 80 associated with the task 32 (Block 206).

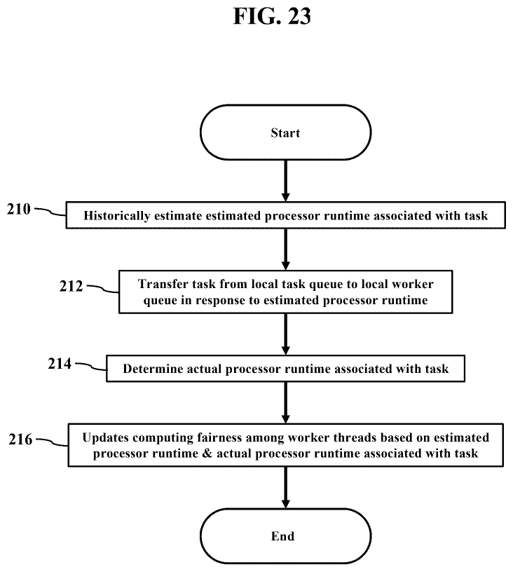

FIG. 23 illustrates more examples of a method or operations executed by the operating system 26 that improves the computing fairness 20 among the worker threads 38. The scheduler thread 40 historically estimates the estimated processor runtime 50 associated with the task 32 (Block 210). The scheduler thread 40 transfers the task 32 from the local task queue 36 to the local worker queue 42 in response to the estimated processor runtime 50 (Block 212). The scheduler thread 40 determines the actual processor runtime 80 associated with the task 32 (Block 214). The scheduler thread 40 updates the computing fairness 20 among the worker threads 38 based on the estimated processor runtime 50 and the actual processor runtime 80 associated with the task 32 (Block 216).

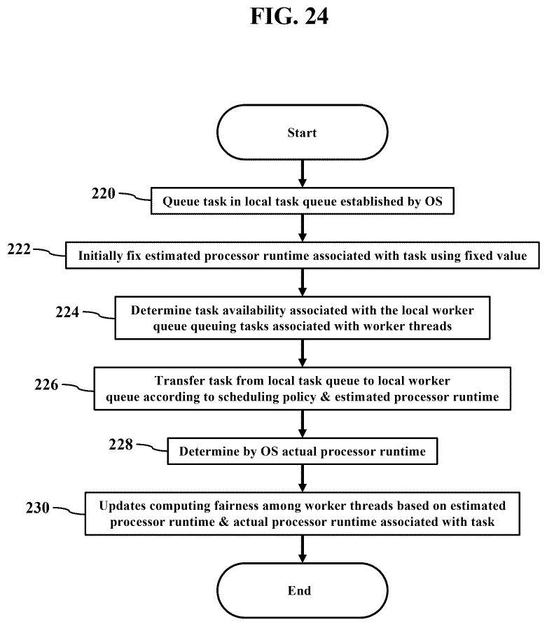

FIG. 24 illustrates still more examples of a method or operations that improve the computing fairness 20 among the worker threads 38. The scheduler thread 40 queues the task 32 in the local task queue 36 established by the operating system 26 (Block 220). The scheduler thread 40 randomly estimates the estimated processor runtime 50 associated with the task 32 queued in the local task queue 36 by using the random number generated by the random number generator 100 and the baseline processor runtime 102 (Block 222). The scheduler thread 40 determines, and/or is notified of, the task availability 90 associated with the local worker queue 42 queuing the tasks 32 associated with the worker threads 38 (Block 224). The scheduler thread 40 transfers the task 32 from the local task queue 36 to the local worker queue 42 according to the scheduling policy 44 based on the estimated processor runtime 50 (Block 226). The scheduler thread 40 determines (such as a notification from the operating system 26) the actual processor runtime 80 associated with processing the task 32 by a worker thread 38 (Block 228). The scheduler thread 40 updates the computing fairness 20 among the worker threads 38 based on the estimated processor runtime 50 associated with the task 32 and the actual processor runtime 80 associated with the processing of the task 32 by the worker thread 38 (Block 230).

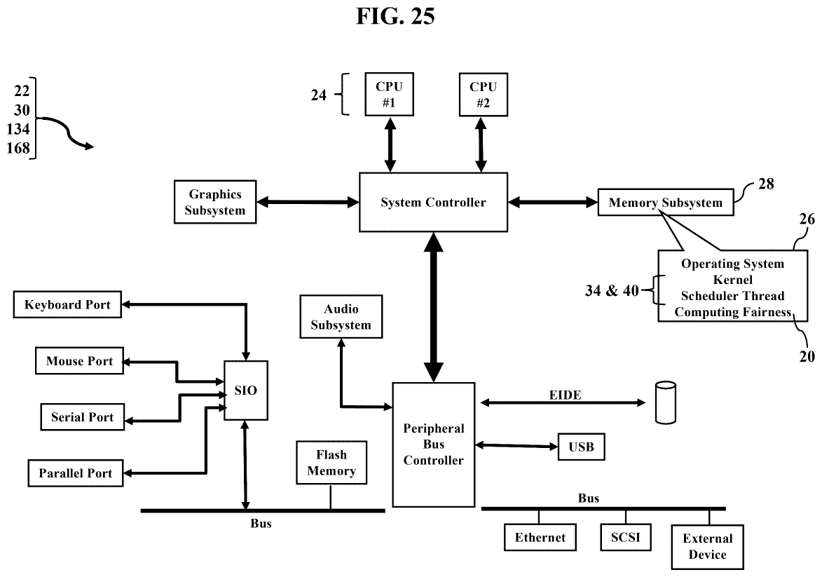

FIG. 25 illustrates a more detailed example of the operating environment. FIG. 21 is a more detailed block diagram illustrating the computer system 22. The computer system 22 may represent the computer server 30, the node 134, and the worker 168. The operating system 26, the kernel 34, and the scheduler thread 40 are stored in the memory subsystems or devices 28. One or more of the processors/cores 24 communicate with the memory subsystem or device 28 and execute the operating system 26, the kernel 34, and the scheduler thread 40. The operating system 26, the kernel 34, and the scheduler thread 40 implements the computing fairness 20 to ensure fair access to the processors/cores 24. Examples of the memory subsystem or device 28 may include Dual In-Line Memory Modules (DIMMs), Dynamic Random Access Memory (DRAM) DIMMs, Static Random Access Memory (SRAM) DIMMs, non-volatile DIMMs (NV-DIMMs), storage class memory devices, Read-Only Memory (ROM) devices, compact disks, solid-state, and other read/write memory technology. Because the computer system 22 is known to those of ordinary skill in the art, no detailed explanation is needed.

The computer system 22 may have other embodiments. This disclosure mostly discusses the computer system 22 as the computer server 30, the node 134, and the worker 168. The computing fairness 20, however, may be easily adapted to other operating environments, such as a switch, router, or other network member of the computing cluster 136. The computing fairness 20 may also be easily adapted to other devices, such as where the computer system 22 may be a laptop computer, a smartphone, a tablet computer, or a smartwatch. The computing fairness 20 may also be easily adapted to other embodiments of smart devices, such as a television, an audio device, a remote control, and a recorder. The computing fairness 20 may also be easily adapted to still more smart appliances, such as washers, dryers, and refrigerators. Indeed, as cars, trucks, and other vehicles grow in electronic usage and in processing power, the computing fairness 20 may be easily incorporated into a vehicular controller.

Computing fairness 20 may be applied regardless of the networking environment. The computing fairness 20 may be easily adapted to stationary or mobile devices having wide-area networking (e.g., 4G/LTE/5G cellular), wireless local area networking (WI-FI®), near field, and/or BLUETOOTH® capability. The computing fairness 20 may be applied to stationary or mobile devices utilizing a portion of the electromagnetic spectrum and a signaling standard (such as the IEEE 802 family of standards, GSM/CDMA/TDMA or other cellular standard, and/or the ISM band). The computing fairness 20, however, may be applied to a processor-controlled device operating in the radio-frequency domain and/or the Internet Protocol (IP) domain. The computing fairness 20 may be applied to a processor-controlled device utilizing a distributed computing network, such as the Internet (sometimes alternatively known as the “World Wide Web”), an intranet, a local-area network (LAN), and/or a wide-area network (WAN). The computing fairness 20 may be applied to a processor-controlled device utilizing power line technologies, in which signals are communicated via electrical wiring. Indeed, the many examples may be applied regardless of physical componentry, physical configuration, or communications standard(s).

The computer system 22 may utilize a processing component, configuration, or system. For example, the computing fairness 20 may be easily adapted to a desktop, mobile, or server central processing unit or chipset offered by INTEL®, ADVANCED MICRO DEVICES®, ARM®, APPLE®, TAIWAN SEMICONDUCTOR MANUFACTURING®, QUALCOMM®, or other manufacturer. The computer system 22 may even use multiple central processing units or chipsets, which could include distributed processors or parallel processors in a single machine or multiple machines. The central processing unit or chipset can be used in supporting a virtual processing environment. The central processing unit or chipset could include a state machine or logic controller. When the central processing units or chipsets execute instructions to perform “operations,” this could include the central processing unit or chipset performing the operations directly and/or facilitating, directing, or cooperating with another device or component to perform the operations.

The computer system 22 may use packetized communications. When the computer system 22 communicates via the communications network 132 (illustrated in FIGS. 12-13), information may be collected, sent, and retrieved. The information may be formatted or generated as packets of data according to a packet protocol (such as the Internet Protocol). The packets of data contain bits or bytes of data describing the contents, or payload, of a message. A header of each packet of data may be read or inspected and contain routing information identifying an origination address and/or a destination address.

The communications network 132 may utilize a signaling standard. The communications network 132 and/or the computer cluster 136 may mostly use wired networks to interconnect the network members. However, the communications network 132 and/or the computer cluster 136 may utilize a communications device using the Global System for Mobile (GSM) communications signaling standard, the Time Division Multiple Access (TDMA) signaling standard, the Code Division Multiple Access (CDMA) signaling standard, the “dual-mode” GSM-ANSI Interoperability Team (GAIT) signaling standard, or other variant of the GSM/CDMA/TDMA signaling standard. The communications network and the cloud-computing environment 130 may also utilize other standards, such as the I.E.E.E. 802 family of standards, the Industrial, Scientific, and Medical band of the electromagnetic spectrum, BLUETOOTH®, low-power or near-field, and other standard or value.

The computing fairness 20 may be physically embodied on or in a computer-readable storage medium. This computer-readable medium, for example, may include CD-ROM, DVD, tape, cassette, floppy disk, optical disk, memory card, memory drive, and large-capacity disks. This computer-readable medium, or media, could be distributed to end-subscribers, licensees, and assignees. A computer program product comprises processor-executable instructions for implementing the computing fairness 20 based on the estimated processor runtime 50 and the actual processor runtime 80, as the above paragraphs explain.

The diagrams, schematics, illustrations, and the like represent conceptual views or processes illustrating examples of the computing fairness 20. The functions of the various elements shown in the figures may be provided through the use of dedicated hardware as well as hardware capable of executing instructions. The hardware, processes, methods, and/or operating systems described herein are for illustrative purposes and, thus, are not intended to be limited to a particular named manufacturer or service provider.

As used herein, the singular forms “a,” “an,” and “the” are intended to include the plural forms as well, unless expressly stated otherwise. It will be further understood that the terms “includes,” “comprises,” “including,” and/or “comprising,” when used in this Specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, and so on, may be used herein to describe various elements, these elements should not be limited by these terms. These terms are only used to distinguish one element from another. For example, a first computer or container could be termed a second computer or container and, similarly, a second device could be termed a first device without departing from the teachings of the disclosure.

1. A method executed by an operating system that improves computing fairness among worker threads, comprising:
estimating, by a scheduler thread associated with the operating system, an estimated processor runtime associated with a task;
transferring, by the scheduler thread associated with the operating system, the task from a local task queue to a local worker queue in response to the estimated processor runtime;
determining, by the scheduler thread associated with the operating system, an actual processor runtime associated with the task; and
updating, by the scheduler thread associated with the operating system, the computing fairness among the worker threads based on at least one of the estimated processor runtime and the actual processor runtime associated with the task.

2. The method of claim 1, further comprising selecting a subsequent task in the local task queue in response to the at least one of the estimated processor runtime and the actual processor runtime.

3. The method of claim 1, further comprising incrementing, by the scheduler thread associated with the operating system, a credit counter in response to the estimated processor runtime associated with the task.

4. The method of claim 1, further comprising incrementing, by the scheduler thread associated with the operating system, a penalty counter in response to the actual processor runtime associated with the task.

5. The method of claim 1, further comprising reconciling, by the scheduler thread associated with the operating system, an account associated with the task in response to the estimated processor runtime and the actual processor runtime.

6. The method of claim 1, further comprising counting memory bytes associated with the task that are read from a memory device.

7. The method of claim 6, further comprising determining the actual processor runtime associated with the task based on the counting of the memory bytes read from the memory device.

8. The method of claim 1, wherein the estimating of the estimated processor runtime further comprises assigning a fixed value to the estimated processor runtime.

9. At least one computer system that improves computing fairness among worker threads, comprising:
at least one central processing unit; and
at least one local memory device storing instructions that, when executed by the at least one central processing unit, perform operations, the operations comprising:
historically estimating, by a scheduler thread associated with the operating system, an estimated processor runtime associated with a task;
transferring, by the scheduler thread associated with the operating system, the task from a local task queue to a local worker queue in response to the historically estimating of the estimated processor runtime;
determining, by the scheduler thread associated with the operating system, an actual processor runtime associated with the task; and
updating, by the scheduler thread associated with the operating system, the computing fairness among the worker threads based on the estimated processor runtime and the actual processor runtime associated with the task.

10. The at least one computer system of claim 9, wherein the operations further comprise selecting a subsequent task in the local task queue in response to the estimated processor runtime and the actual processor runtime.

11. The at least one computer system of claim 9, wherein the operations further comprise incrementing, by the scheduler thread, a credit counter in response to the estimated processor runtime associated with the task.

12. The at least one computer system of claim 9, wherein the operations further comprise incrementing, by the scheduler thread, a penalty counter in response to the actual processor runtime associated with the task.

13. The at least one computer system of claim 9, wherein the operations further comprise reconciling, by the scheduler thread, an account associated with the task in response to the estimated processor runtime and the actual processor runtime.

14. The at least one computer system of claim 9, wherein the operations further comprise counting memory bytes associated with the task that are read from a memory device.

15. The at least one computer system of claim 9, wherein the operations further comprise determining the actual processor runtime associated with the task based on the counting of the memory bytes read from the memory device.

16. The at least one computer system of claim 9, wherein the operations further comprise querying a database having a database entry that associates the task to the estimated processor runtime.

17. A memory device storing instructions that, when executed by at least one central processing unit, perform operations that improve computing fairness among worker threads, the operations comprising:
queuing a task in a local task queue associated with a scheduler thread established by an operating system;
determining an estimated processor runtime associated with the task queued in the local task queue by assigning a configurable, fixed value;
determining a task availability associated with a local worker queue queuing tasks associated with the worker threads;
transferring, by the scheduler thread in response to the task availability, the task from the local task queue to the local worker queue queuing the tasks associated with the worker threads according to a scheduling policy based on the estimated processor runtime;
determining, by the scheduler thread, an actual processor runtime associated with processing the task by a worker thread of the worker threads; and
updating, by the scheduler thread, the computing fairness among the worker threads based on the estimated processor runtime associated with the task and the actual processor runtime associated with the processing of the task by the worker thread.

18. The memory device of claim 17, wherein the operations further comprise determining a count of bytes associated with the processing of the task by the worker thread.

19. The memory device of claim 18, wherein the operations further comprise determining the actual processor runtime associated with the task based on the count of the bytes.

20. The memory device of claim 17, wherein the operations further comprise reconciling an account associated with the task in response to the estimated processor runtime and the actual processor runtime.
